(19) United States
(12) Patent Application Publication
(10) Pub. No.: US 2017/0371938 A1
(43) Pub. Date: Dec. 28, 2017

(54) Apparatus And Method For Information Retrieval

(71) Applicant: John R. Ruge, Chicago, IL (US)

(72) Inventor: John R. Ruge, Chicago, IL (US)

(21) Appl. No.: 15/698,126

(22) Filed: Sep. 7, 2017

Related U.S. Application Data
(63) Continuation-in-part of application No. 14/335,408, filed on Jul. 18, 2014.
(60) Provisional application No. 62/449,471, filed on Jan. 23, 2017.

(51) Int. Cl. G06F 17/30

(52) U.S. Cl. CPC G06F 17/30554; G06F 17/3053; G06F 17/30038; G06F 17/30401; G06F 17/30457

(57) ABSTRACT

A topic list is presented to a user. Based upon the topic selection, one or more questions linked to the topic are retrieved automatically. Each question is linked to an optimized search. A topic and question selection from the user is received. The optimized search is retrieved based upon the question selection. Search results are received and presented to the user. The topics, questions and optimized searches are predefined without user input and stored in memory. Also, a handbook with chapters can be provided and updated automatically each time visited by a user without user input. Further, the search results can be automatically displayed in a predefined display format. The format can be predefined before execution of the optimized search by associating each optimized search query with a predesignated area on one or more display pages. Each search result can be associated with a different pixel or set of pixels.

### CROSS-REFERENCE TO RELATED APPLICATIONS

This application is a continuation-in-part of U.S. application Ser. No. 14/335,408, filed Jul. 18, 2014. This application also claims the benefit of U.S. Provisional Application No. 62/449,471, filed Jan. 23, 2017. Both applications are hereby incorporated by reference herein in their entireties.

### TECHNICAL FIELD

The present disclosure relates to information retrieval and, more specifically, to information retrieval and display of such information.

### BACKGROUND

Prior to the internet, physicians searched for new medical treatments, procedures, clinical information or other needed information by consulting printed materials, such as journals or textbooks, or attending medical conferences. In medicine, information changes rapidly, and therefore, printed materials can become outdated quickly, including journals even though they have shorter publication cycles. Upcoming conferences also may not meet the current informational needs of the physician because the topics may not address the situation facing the physician.

Because of the limitations of printed materials and conferences, physicians now turn to the internet to assist them with their informational needs. However, searching the internet can be frustrating for some. For instance, some physicians may not find the information they are looking for because they may not be using good search techniques, which would include knowing how to formulate searches and what sites to search. This may lead them to not use the internet. Other dissatisfactions stem from shortcomings with conventional search engines in processing medical-related inquiries. For instance, these search engines often return results with highly marketed sites that have been optimized by heavy cross-linking at the top of the results. Thus, the more cross-linked sites are often not the ones with the more valuable information. If relevant information is eventually identified, it commonly happens after several search attempts and many hours of reviewing the search results. Even then, no mechanism exists to store it in an easily retrievable format for future use or analysis. Finally, there is no efficient and effective way to search remotely, such as with a smartphone. It is difficult to sift through large amounts of information using a mobile search device.

All of these shortcomings have led to a general dissatisfaction with using the internet to perform efficient and effective targeted searching. While the foregoing references the medical field, these shortcomings are not limited to this field and are present in a vast number of fields and professions, especially those with fast changing information.

### BRIEF DESCRIPTION OF THE DRAWINGS

FIG. 1 comprises a flow chart showing one approach for information retrieval from a mobile device according to various embodiments of the present invention;

FIG. 2 comprises a flow chart showing one approach for information retrieval from a mobile device according to various embodiments of the present invention;

FIG. 3 comprises a block diagram of a data structure according to various embodiments of the present invention;

FIG. 4 comprises a block diagram of a mobile device according to various embodiments of the present invention;

FIG. 5 comprises a block diagram of various screens showing results according to various embodiments of the present invention;

FIG. 6 comprises a flow chart showing one approach for information retrieval from a mobile device involving medical applications according to various embodiments of the present invention;

FIG. 7 comprises a screen shot of one example of a topic screen according to various embodiments of the present invention;

FIG. 8 comprises a screen shot of one example of a question screen according to various embodiments of the present invention;

FIG. 9 comprises a screen shot of one example of a results screen according to various embodiments of the present invention;

FIG. 10 comprises a block diagram showing one example of a search according to various embodiments of the present invention;

FIG. 11 comprises a block diagram showing one example of a live book according to various embodiments of the present invention;

FIG. 12 comprises one example of a layout for a live book according to various embodiments of the present invention;

FIG. 13 comprises a block diagram showing one example of a live book according to various embodiments of the present invention; and

FIG. 14 comprises an exemplary live document illustrating various shapes and sizes for areas used to display associated search results.

### DETAILED DESCRIPTION

The approaches described herein utilize applications deployed on mobile devices, such as smartphones, cellular phones, and tablets, and personal computers. The approaches are efficient and effective tools for obtaining highly relevant information.

In one example, there is provided an approach for the retrieval, organization, and storage of relevant medical information related to cancerous tumors. The relevant information is rapidly acquired from the Internet using enhanced search strings. The information can then be stored in an easily retrievable format, emailed, and/or printed. The information also can be presented in any form or format, such as in a textual format, an image, or a video to mention a few.

In other aspects, the approaches create a “live book” for any topic (not just cancer) where the user chooses the topic and the web/mobile application then refreshes embedded searches to generate a unique (i.e., always new with each use) “book” on the chosen topic. The application facilitates the creation of a library of articles, images and videos of particular interest and value. For example, a continually updated reference manual for the medical practitioner in a particular field can be created using this application.

These approaches reduce and even eliminate the frustrations associated with existing search engines and techniques looking to find specific and targeted information. The application automatically presents topics and questions for selection and, then, automatically performs the search and presents the results to the user at a mobile device. The user is not required to have special knowledge of search engine preferences or honed Internet searching skills in order to quickly find relevant material.

To take one example involving cancerous tumors, experience teaches that the questions asked are often the same as between users regardless of the type of tumor. From another view, although the information is changes quickly, the questions typically remained the same. The present approaches focuses on identifying the questions and then optimizing the searching based on the questions. This has been found to retrieve very useful results quickly.

Once the questions are identified, they may be included and stored as a list. Each question is then embedded (or the list is embedded) in the memory of the mobile device. The user selects the question, for example, about the specific tumor type or procedure of interest. An optimized search is performed, and the results of the search are displayed automatically and dynamically in a useable, user-friendly format, such as a list.

The approaches here are more efficient and effective at retrieving relevant medical information from the Internet than previous approaches for several reasons. For instance, the embedded search queries have been optimized using appropriate techniques, such as best Boolean search strings (where the search string is vetted so as to yield the optimal results). Consequently, trial-and-error techniques of previous approaches are avoided.

Other advantages include using only pre-selected, vetted websites for searching. In addition to text, images and videos also are located and included in the search results. The addition of images and videos provides more useful and enhanced search results over conventional techniques that provided text only.

For some situations, the application can be designed with a very narrow focus (e.g., cancer based). In this case, the questions are very directed and specific to find relevant and targeted results. For example, if the application relates to cancer, the questions are designed and selected by doctors and experts in oncology.

In another aspect, embedded questions are trended to allow the application to grow and provide even more relevant results over time. In one example, the order of questions presented to a user changes over time so that the questions that users are actually using are provided to the user in order of priority. The change can occur automatically using predetermined criteria, such as statistical analysis where a preset threshold of a lower listed question is being used more than a higher listed question.

A number of approaches for information retrieval from a mobile device are described. Although the approaches are particularly advantageous when executed using a mobile device, it will be appreciated that these approaches may be performed or created at any location or device, regardless of whether the device is mobile or not. Further, even though many examples described herein relate to medical topics (e.g., cancerous tumors), it will be understood that the approaches are not limited to this field and can be extended to other fields and professions.

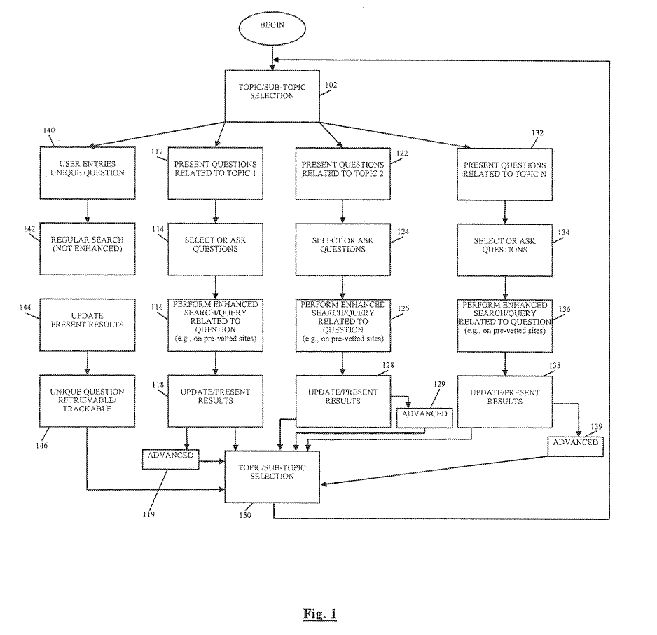

With reference to FIG. 1, step 102 references selecting a topic and/or sub-topic. This step 102 may present several screens to the user to allow the selection. For example, a user may select a topic from a topic screen, and this selection may lead to other sub-topic screens where a sub-topic list is presented to the user for selecting a sub-topic.

Depending on the topic, various sequences of steps may be executed. For example, steps 112-118 are executed if topic 1 is chosen; steps 122-128 are executed if topic 2 is chosen; and steps 132-138 are executed if topic “n” is chosen. Additionally, steps 140-146 are executed if a user elects to enter their own question, rather than view a list of vetted, embedded questions. The topics may relate to any item information, but in one example relate to different types of cancerous tumors. Other examples of topics are possible.

At steps 112, 122, or 132, questions related to a particular topic are presented to the user. They are presented on a user interface (e.g., a graphical display). In one situation, the questions may be presented as icons. At steps 114, 124, or 134, a question selection is made such as by tapping the icon on the screen. Other selection approaches are possible. By selecting the question, a search is executed by the application at steps 116, 126, or 136.

An enhanced type searching related to the question is performed. In one aspect, enhanced searching refers to using search queries that are optimized in advance by the application provider. This optimization may employ expertise in the particular field being searched as noted above. The application provider optimizes the searches, for example, by actually testing different search queries (e.g., which may take the form of a Boolean search string) for the same question in order to determine which search query generates the best results. The application provider may further choose which websites are to be searched, further optimizing search results.

A Boolean search string is typically the format used by search engines to generate search results. Quotation marks, parenthesis, and Boolean terms such as “and,” “or,” “near,” and “not,” as well as combinations of these terms can be used to optimize search results. For example, where A, B, and C are search terms, the search string (A and (B or C)) may be an optimized search that is the best search associated with a particular question as opposed to A and B and C.

At steps 118, 128, or 138, search results are presented to the user. For example, the search results may be presented at a graphical user interface (e.g., a touch screen) of a mobile device.

At steps 119, 129, or 139, an advanced search may be initiated. The advanced search feature allows the enhanced search to be further refined. For instance, in the advanced search, additional modifying terms may be used to refine or filter the results of the enhanced search string.

As mentioned, the user can optionally enter their own questions rather than use the pre-vetted questions. In these regards, step 140 refers to where the user can enter a question not on the pre-vetted list. At step 142, an unenhanced search may be performed using the question of step 140. At this step, any search engine (e.g., Google) can be used with the search terms merely inserted as a string of terms.

At step 144, if the application provider determines that a sufficient number of users are asking the same new question, then this new question can be enhanced and added to the embedded enhanced list. At step 146, the new question is retrievable and tracked by the application provider to enable this analysis.

At step 150, questions may be updated or order of questions changed. For example, questions that the user entered may be added to the embedded enhanced list. The order of the questions also may be changed based upon the popularity of the questions selected by various users. For example, the more popular questions may be ordered higher in the list compared to other, less popular questions.

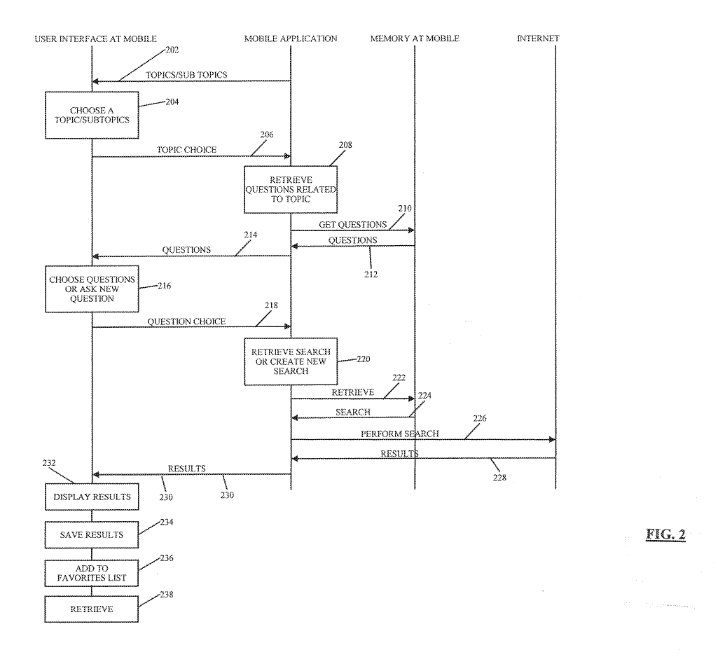

Referring now to FIG. 2, one example of an approach for information retrieval from a mobile device is described. FIG. 2 shows the occurrence of events and the flow of information at and between the interface (e.g., screen) of the mobile device, the mobile application, the memory at the mobile device, and the Internet. The mobile application may be executed at a mobile device such as a cellular phone, tablet, personal computer, or a personal digital assistant to mention a few examples. Other examples of mobile devices are possible.

At step 202, a topic/subtopics list is sent from the mobile application to the user interface (screen) for presentation to a user. For example, for a cancer tumor application, a list of all tumor types may be sent to the user interface.

At step 204, the user selects a topic. For a tumor-searching application, the user may select a tumor name from the tumor list. For example, the user may tap an icon on their screen to make the selection.

At step 206, the topic choice is sent to the application. For instance, and continuing to use the preceding example, the name of the selected tumor is sent to the application.

At step 208, the mobile application forms commands to retrieve a question list from memory. The question list retrieved relates to the selected topic. More specifically, the question list is pre-vetted, for example, by an application provider to provide the most relevant questions related to a topic.

At step 210, commands are sent to the memory of the mobile device to obtain the questions or question list. At step 212, the questions or question list are retrieved from memory. At step 214, the questions or question list are sent to the user interface for presentation to the user.

At step 216, the user chooses the question using the user interface. The user may, for instance, tap an icon on the display of their mobile device. At step 218, the question choice selected by the user is forwarded to the application.

At step 220, the application executes steps to retrieve the search or create a new search where none exists. For example, the application may form commands to retrieve the enhanced search associated with the question from the memory. At step 222, commands are sent to retrieve the search.

At step 224, the enhanced search associated with the selected question is retrieved from the memory. At step 226, the search is executed. In these regards, commands may be sent to the Internet to obtain appropriate information. At step 228, the Internet sends the search results to the mobile application. At step 230, the mobile application sends the search results to the user interface for presentation to the user.

At step 232, the search results are displayed. For example, the results are displayed on the graphical user interface of the user so that the user can peruse them. The search results may themselves have embedded links (e.g., hypertext links). The user can then select the appropriate link (e.g., by tapping the link), and the application will allow the web page associated with the link to be presented to the user.

At step 234, the search results can be saved, for example, in the memory of the mobile device or printed. At step 236, the user can optionally add the topic selection and question selection to a favorites list. The favorites list can be recalled at a future time and the topic and its related search can be easily retrieved without the user having to go through the various selection steps. At step 238, the user can retrieve previous selections/searches that are stored in memory.

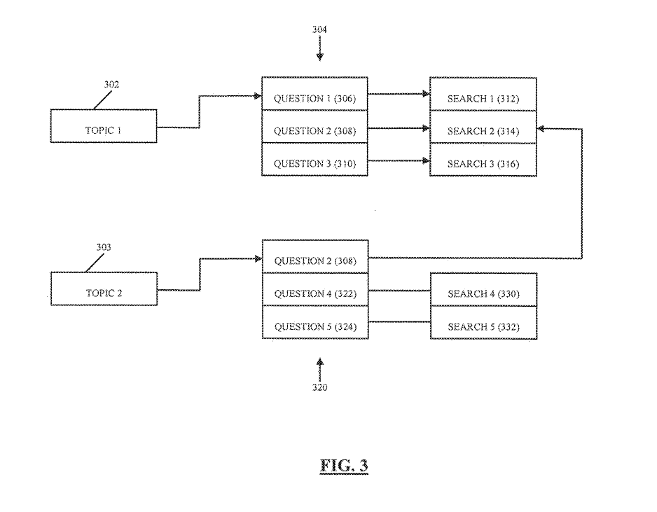

Referring now to FIG. 3, a data structure showing relationship of questions and searches will be described. It is to be appreciated that this is one representation of a data structure and that other data structures are possible. Also, the data structure can be programmed according to a number of know programming languages.

A first topic 302 (Topic 1) points to (or indicates) a first list of questions 304. Each question (e.g., a first question 306, a second question 308, and a third question 310) points to (or indicates) an enhanced search. More specifically, the first question points to (or indicates) a first enhanced search 312, the second question 308 points to (or indicates) a second enhanced search 314, and the third question 310 points to (or indicates) a third enhanced search 316. As discussed above, each of the searches 312, 314, and 316 are predetermined strings of search terms that are organized and/or optimized using Boolean operators/constructs to achieve the best search results.

A second topic 303 (Topic 2) points to (or indicates) a second list of questions 320. Each question (a second question 308 (the same as in the first list), a fourth question 322, and a fifth question 324) points to (or indicates) a search. More specifically, the second question 308 points to (or indicates) the second search 314, the fourth question 322 points to (or indicates) a fourth search 330, and the fifth question 324 points to (or indicates) the fifth search 332. Each of the searches 314, 330, and 332 are predetermined strings of search terms that are organized or optimized using Boolean operators/constructs to achieve the best search results.

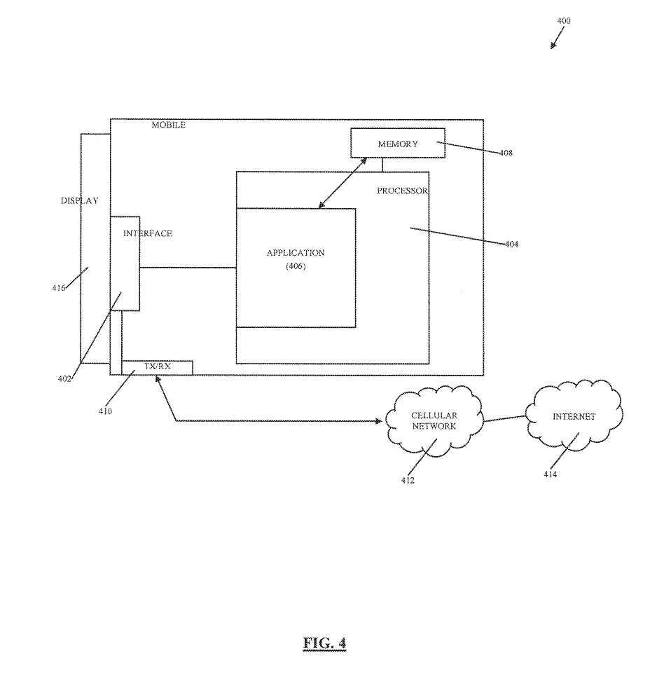

Referring now to FIG. 4, one example of a mobile device 400 that runs an application is described. The mobile device may be a cellular phone, smartphone, tablet, personal computer, or a personal digital assistant to mention a few examples. Other examples of mobile devices are possible, including those dedicated primarily to the function of these approaches.

The mobile device 400 includes an interface 402, a processor 404 that runs an application 406, a memory 408, a display 416, and a transmitter/receiver 410. The device 400 communicates with the internet 414 through a network 412.

The interface 402 provides a hardware and/or software interface between the display 416, the processor 404 and the transmitter/receiver 410. The processor 404 is any appropriate processing device (such as a microprocessor), and the memory is any type of computer memory. The application 406 manages information needed by the user to select topics and questions, retrieves searches, transmits search requests to search engines to perform searches, and performs other functions described herein.

The transmitter/receiver 410 transmits and receives information from the cellular network 412. In these regards, it is to be appreciated that the network 412 may be any combination of any type of networks, such as cellular networks, Ethernet compatible networks, local area networks, or wide area networks, wife enabled networks to mention a few examples.

The Internet 414 is the World Wide Web having various gateways, routers, and servers. The display 416 is any graphical user interface and may be a screen, touch screen, key pad, computer mouse, or any combination of these or other elements that allow a user to communicate or receive information from the mobile device 400.

In one example of the operation of the mobile device 400, a topic selection from a user is obtained, from a user indicating the topic at the display 416. For instance, the display 416 may be a touch screen, which the user touches to choose a topic. In another example, the display 416 may have an associated keyboard where the user types in information to indicate a topic selection.

Based upon the topic selection, one or more questions (e.g., in the form of a question list) are retrieved from the memory 408 of the mobile device 400. Each of the questions on the list has been linked to an optimized search, and this linkage also is stored or embedded in the memory 408. Each optimized search further is stored or embedded in the memory 408. The display 416 may be a touch screen, which the user touches to choose a question on the list. In another example, the display 416 may have an associated keyboard that the user uses to navigate the display or others types in information to indicate a question selection. The questions (or question list), enhanced searches, and linkage between the questions and the searches may be downloaded from an application provider at appropriate times. These also may be updated automatically or manually on the mobile device from the application provider.

The optimized search is retrieved from the memory 408 based upon the question selection of the user. A search may be sent via transmitter/receiver 410 to the cellular network 412 and the Internet 414. Search results accomplished by the search at the Internet 414 are received at the transmitter/receiver 410 and presented to the user at the display 416 via the interface 402.

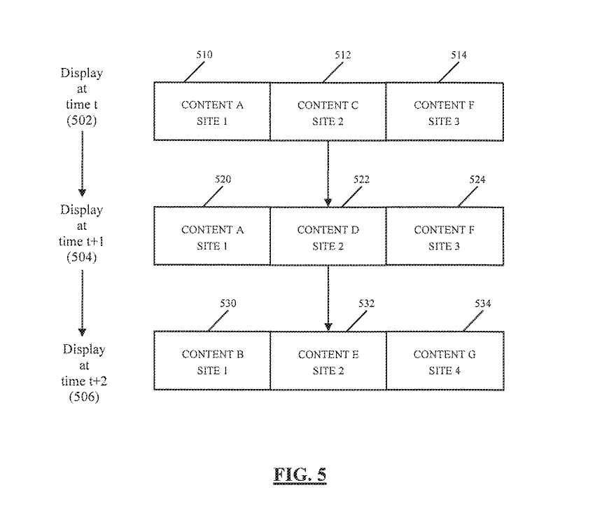

Referring now to FIG. 5, various examples of displays that can be presented to users are described. A first display 502 is presented at time t, a second display 504 is presented at time t+1, and a third display 506 is presented at time t+2. FIG. 5 illustrates the dynamic and changing nature of search results that are presented to a user. That is, as time changes, different search results with different contents and from different websites may be presented to users.

The first display 502 includes a first content 510 (Content A, website 1), a second content 512 (Content C, website 2), and a third content 514 (Content F, website 3). Subsequently, when the second display 504 is made, it includes a first content 520 (Content A, website 1), a second content 522 (Content D, website 2), and a third content 524 (Content F, website 3). Thus, the content presented from website 2 has changed from time t to time t+1. It is to be understood that Content A differs from Content B, Content B differs from Content C, and so forth.

Subsequently, when the third display 506 is made, it includes a first content 530 (Content B, website 1), a second content 532 (Content E, website 2), and a third content 534 (Content G, website 4). Thus, the content from website 1 has changed, the content of website 2 has changed again, and website 3 has been replaced with website 4 having a new and different content.

Thus, the present approaches can be used to create a “live book” for any topic (not just cancer) where the user chooses the topic and the web/mobile application then refreshes embedded searches to generate a unique (i.e., always new with each use) “book” on that topic. The live book is digital book with electronically displayed organized units of text, images and videos. It is organized around a particular topic that is constructed with embedded searches. The live book also can be refreshed in the future to be updated as explained further below. The live book could then be printed if desired. As can be seen in the example above, each display may be considered presentation of the live book, and the content of that live book changes over time. It is to be appreciated that the application can automatically update the book with no user intervention. Alternatively, the user could initiate a refresh of the book as desired.

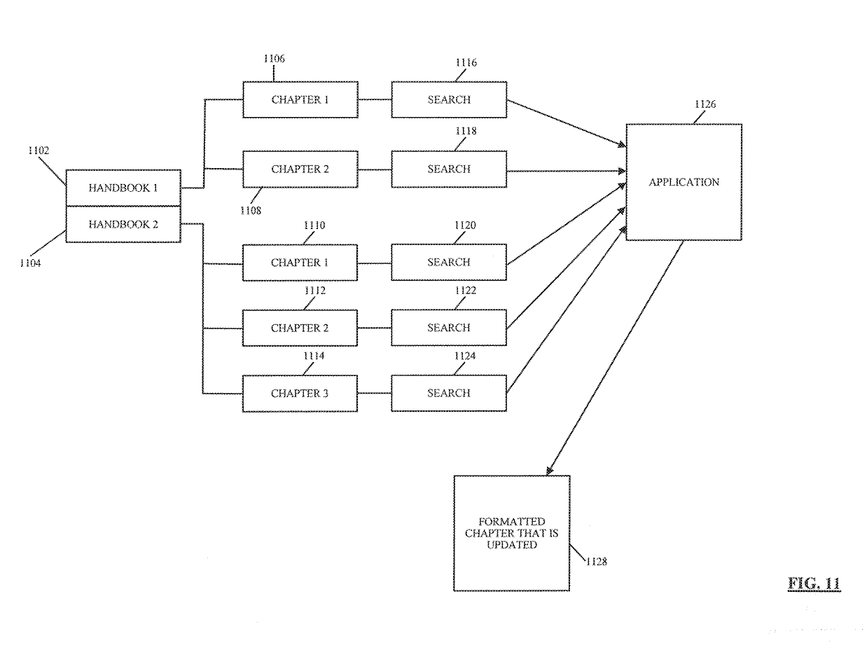

In one particular example of a “live book” and now referring to FIG. 11, a live book data structure (e.g., stored at a memory at the user's mobile device) includes a hand book list that includes a first hand book 1102 and a second hand book 1104. The first hand book 1102 points to (or indicates) a chapter list that includes chapters 1106 and 1108. The chapters 1106 and 1108 point to (or indicate) embedded searches 1116 and 1118, respectively. The second hand book 1104 points to (or indicates) a chapter list that includes chapters 1110, 1112, and 1114. The chapters 1110, 1112, and 1114 point to (or indicate) embedded searches 1120, 1122, and 1124, respectively. The searches may be implemented as Boolean search strings and selected according to the approaches described elsewhere herein.

An application 1126 operating on a mobile device receives a handbook and chapter selection from a user. The application 1126 automatically performs the embedded search associated with a particular chapter, formats the results into an appropriate format, and presents the formatted and updated chapter 1128 to the user. The format can take a form like text of a book, including with pictures, images and video. It also could have citations and footnotes. The citations and footnotes can be presented as hypertext links. The user can then view the chapter on an appropriate interface such as the touch screen of their mobile device.

In this way, a particular chapter or (or group of chapters or an entire book) is automatically and dynamically updated by an application using the embedded and optimized searches that are described herein. A particular handbook or book is always current and updated every time a user wishes to access and read the book (or portion of the book). The updated information is presented and rendered to the user as requested by the user, rather than continuously thereby saving power and processor bandwidth at the user's mobile device.

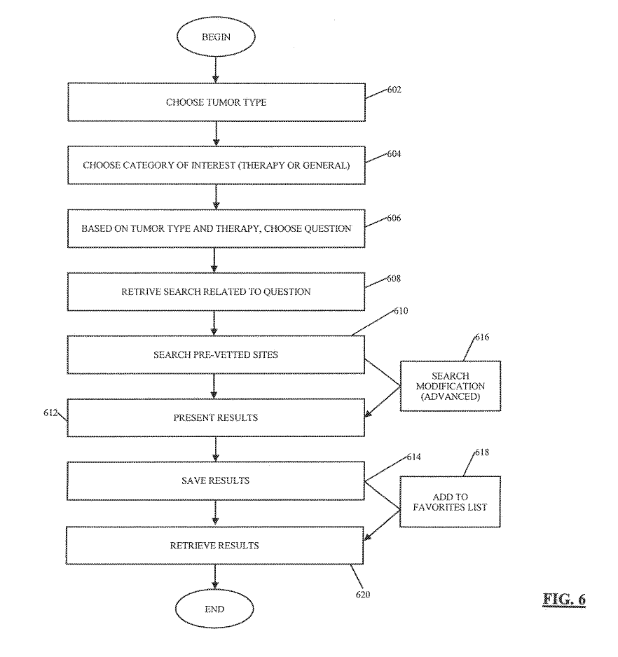

Referring now to FIG. 6, one example of an approach for information retrieval from a mobile device in a medical field is described. It is to be appreciated that this is one example of an approach related to the retrieval of medical information and that other examples are possible in this field as well as many other fields.

At step 602, a tumor type is selected. For example, for a list of tumor types beginning with the letter “a,” “anaplastic astrocytoma” may be selected. At step 604, a category of interest is selected (e.g., therapy or general). This selection may be further used to narrow the questions that are presented to the user.

At step 606, a question is selected. The question is a pre-vetted question, and the questions on the list may be ordered based, for instance, on popularity amongst users.

At step 608, a search related to the question is retrieved. More specifically, each question has an associated enhanced search. As mentioned previously, the search may be optimized by the application provider (or potentially others) using Boolean constructs to achieve the best results. In these regards, the application provider performs tests with various search strings, analyzes the test results (to determine which search string structure yields the best results), and chooses the search string structure that achieved the best results. A linkage between the search string and the question also is established by the application provider.

At step 610, the search is made at pre-vetted sites. For example, some websites may not have useful information, may include erroneous information, or may be commercial sites only interested in selling products or services to users. Consequently, in order to optimize search results, these undesired sites may be ignored and not searched while other sites known to have relevant information will be included in the optimized search.

At step 612, the search results are presented to a user. For example, the search results may be presented at a graphical user interface on a mobile device.

At step 614, the search results can be saved. For example, the search results may be saved locally in the memory of the mobile device for future analysis. The results also may be uploaded to a network (e.g., a cloud network) for future retrieval and analysis by the user.

At step 616, optionally the search can be modified by using the advanced search option. By this option, further modifications to the search are allowed and made. For example, the search can be modified according to relevance or date and rank the results based upon these criteria. In one example, the modifications can narrow the search based upon age of the patient and the location in the nervous system of the tumor. Other refinements of known nature are contemplated in these approaches.

At step 618, the user can optionally add the topic selection and question selection to a favorites list. The favorites list can be recalled at a future time and the topic and its related search can be easily retrieved without the user having to go through the various selection steps. At step 620, the user can retrieve previous selections/searches that are stored in memory.

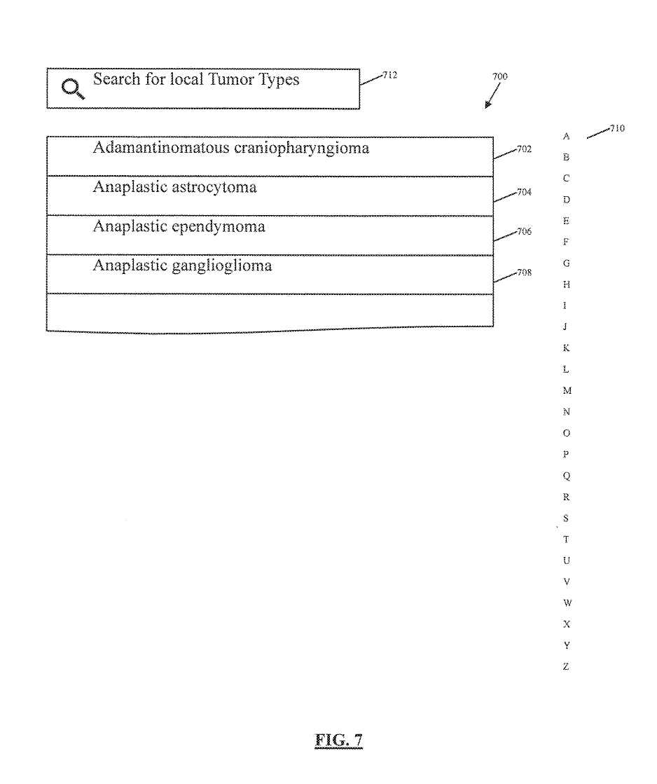

With reference to FIGS. 7-9, examples of screen shots showing results of searches are described. FIG. 7 shows one example of an initial topic screen 700 that is presented to a user. The screen 700 shows topics 702, 704, 705, and 708. Alphabetical lookup area 710 allows a user to click on any of the letters to find tumor types beginning with a particular letter. A search box 712 additionally allows a user to search for a tumor type by directly entering the name of the tumor in the search box 712 to determine if the tumor is included as a covered topic.

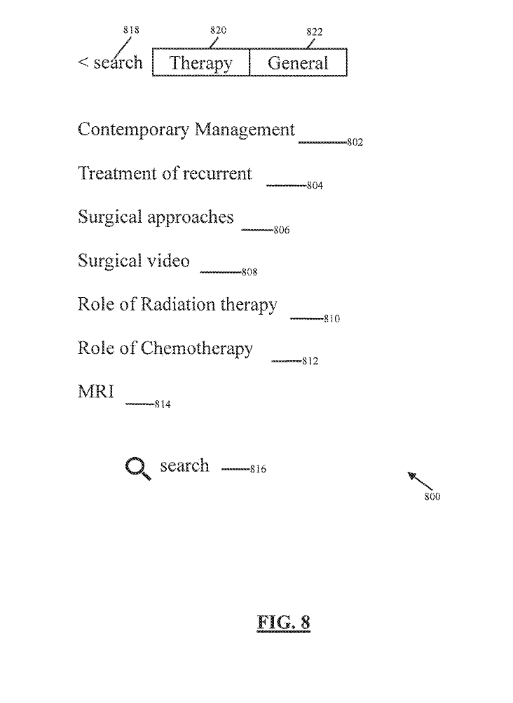

FIG. 8 shows a questions screen 800 that is presented to the user when the “anaplastic astrocytoma” topic (indicated by label 704) in FIG. 7 is selected. The screen 800 includes questions 802, 804, 806, 808, 810, 812, and 814. The screen 800 also allows a search to be made via a box 816 or a return to the topic screen by selection of an icon 818. Additionally, the screen 800 allows selection of questions based upon a therapy (represented by icon 820) or general questions (represented by an icon 822).

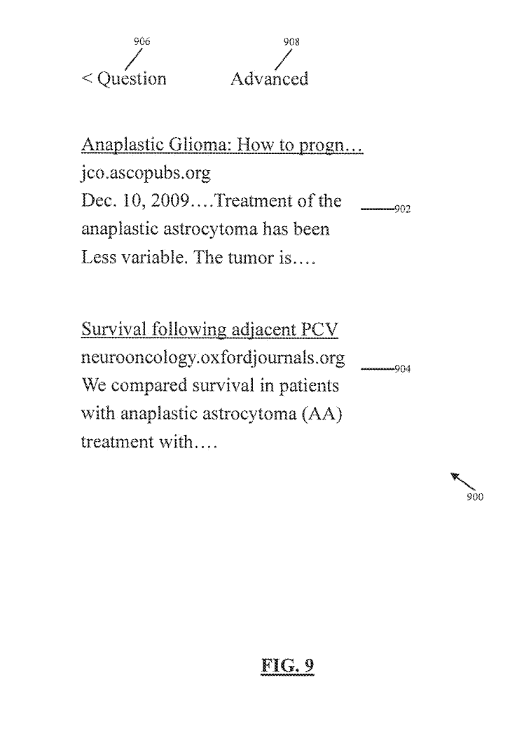

FIG. 9 shows the results screen 900 when the “treatment of recurrent” element 804 of FIG. 8 is selected. The “treatment of recurrent” question has an enhanced search associated with it, and FIG. 9 shows the results of performing that search. In these regards, the screen 900 includes search results 902 and 904. An icon 906 allows a user to return to the questions screen 800 of FIG. 8. Advanced button 908 allows a user to perform an advanced search as described above. Search results also may include hypertext links, which may be selected by a user to take the user to the website associated with the hypertext link.

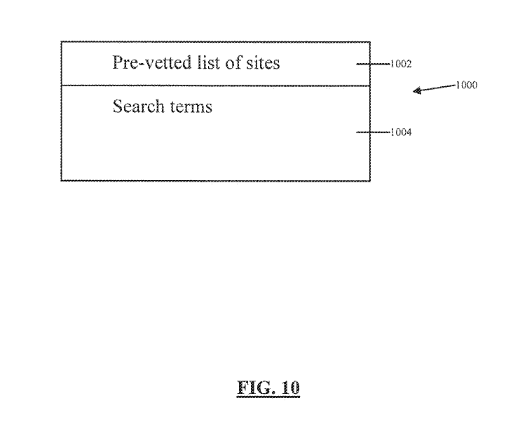

Referring now to FIG. 10, one example of a search 1000 is shown. The search 1000 includes a list of pre-vetted sites 1002 that will be searched. The search includes a list of search terms 1004, for example, organized as a search string. In one aspect, searches are optimized by the application provider. The application provider optimizes with Boolean structures, for example, by actually testing different search queries for the same question in order to determine what structure generates the best results. The application provider also chooses which websites are to be searched, further optimizing search results.

A Boolean search string is a format used by search engines and Internet searches to generate search results. Quotation marks, parenthesis, and Boolean terms such as “and,” “or,” “near,” and “not,” as well as combinations of these structures, can be used to optimize search results.

In one example, a physician user may seek information concerning an anaplastic astrocytoma tumor. It has been found that the search string “treatment of recurrent anaplastic astrocytoma” typically generates sub-optimal results. However, if the search string is “treatment” and “recurrent anaplastic astrocytoma,” it has been found that the search results are more relevant and useful. Even better results are typically obtained at specialized sites because the websites searched are specific to a particular topic (e.g., brain tumor therapy).

The application provider can track very specific usage of the application, and the question list can be optimized. For example, questions that are rarely searched can be eliminated. The most frequent questions used can be listed first. Questions added by the user can be optimized and included in the systems' list. The application provider may utilize specialists in search engine result optimization and/or the particular field of interest so that the search string structure is optimal and the websites are properly selected. Searches can be further revised by the application provider with user feedback.

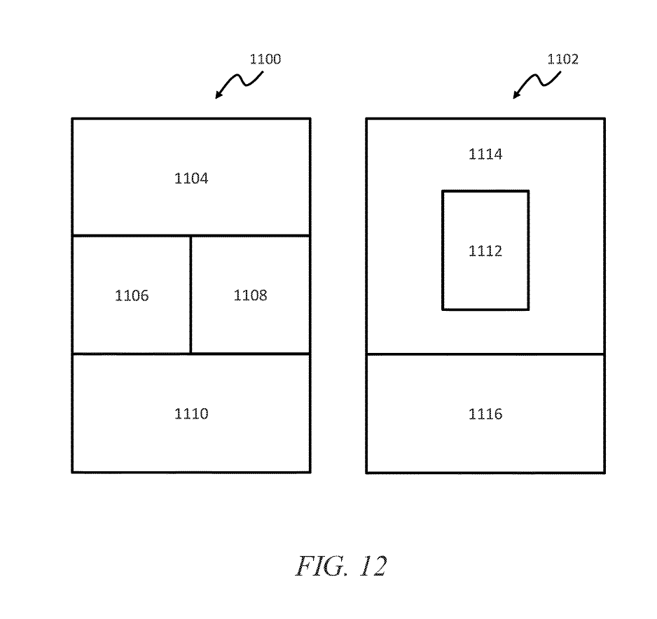

The live book predefined format can have a prearranged layout based on assignment of the question or query to a specific location on the display page. For example, FIG. 12, illustrates an example of prearranging the search results on two display pages 1100, 1102. The live book could be any number of pages from one to the number desired to present the information. The live book could also take a more simple form such as that of a live document that conveys the information. The document could be any presentation of information that may change over time that needs to be updated. One example could be a map of a country where the population changes over time.

As shown, the first display page 1100 includes a layout with four areas. Each area is assigned to or associated with one of predetermined optimized search query Nos. 1-4 or its results. Accordingly, the results 1104 from query No. 1 occupy the top third of the display page, the results 1106, 1108 from query Nos. 2 and 3 each occupy one half of the middle third of the display page, and the results 1110 from query No. 4 occupy the bottom third of the display page. The second display page 1102 includes a layout with three areas. Each area is assigned to or associated with one of predetermined optimized search query Nos. 5-7 or its results. The results 1112, 1114 from query Nos. 5 and 6 occupy the top two thirds of the display page. The results 1112 from query No. 5 can be centered in the top two thirds of the display page. The results 1114 from query No. 6 can wrap around the designated area for the results 1112 of query No. 5. The results 1116 of query No. 7 occupy the bottom third of the display page.

To assist with the above described layout, the predetermined optimized search query or its results can be associated with or assigned to different sets of pixels of the display. For example, again with reference to FIG. 12, the areas of the first and second display pages 1100, 1102 each can be defined by a set of pixels. More specifically, the results 1104 from query No. 1 can occupy a set of pixels representing the top third of the display page, the results 1106, 1108 from query Nos. 2 and 3 can occupy two sets of pixels, each representing one half of the middle third of the display page, and the results 1110 from query No. 4 can occupy a set of pixels representing the bottom third of the display page. The results 1112, 1114 from query Nos. 5 and 6 can occupy two different sets of pixels. That is, the results 1112 from query No. 5 can occupy a set of pixels centered in the top two thirds of the display page, and the results 1114 from query No. 6 can occupy a set of pixels that wrap around the set of pixels for the results 1112 of query No. 5. The results 1116 of query No. 7 can occupy a set of pixels defining the bottom third of the display page.

This example uses sets of pixels to designate areas for the retrieved and displayed information. The approach is not limited to sets of pixels. It can be set to any level of granularity desired for the results. For instance, the level could be reduced to a single pixel level. In the case of a single pixel level, each predetermined optimized search could be assigned or associated with a single pixel. One example of this could be a document having a color map of a country representing a population gradient. Each pixel of the map could display a color representing the population as a color scale. The color could become darker as the population increases. For example, the color on the map would be light in rural areas and darken moving toward the cities. The predetermined optimized search queries could be for the population associated with the location represented by the pixel.

The queries can be for results in any format, including, but not limited to, text, image, audio video, color sound, odor, etc. The display pages also can include hyperlinks to the source of the displayed information or to further information related to the particular results of the area of the page. The live book can have as many sequential pages as needed to cover the topic(s). Each time the live book is retrieved, it can be set to automatically update to provide the most recent information. Further, the live book could be set to only update certain search queries. The search using the predetermined optimized queries for the live book can be limited to using only pre-selected websites. The pre-selected websites are vetted for their content and quality of sources. Further, two or more of the search queries could be processed at the same time to increase the speed of producing and/or updating the live book. For example, all four of the search queries associated with display page one 1100 could be executed at the same time.

The layout of the live book display pages can be preformatted by the developer. Alternatively, the system could provide the user with preformatted page template layouts provided by the developer from which the user can choose, or it could provide the ability to create customized page layouts. For example, the system could provide the user with a tool to create and designate areas on each display page and then assign the search queries to the areas or sets of pixels of the display page. The assignment of the search queries can be done using the questions that are each associated in memory with both a topic and a particular predetermined optimized search query. The user then can assign the questions to the areas or sets of pixels of the page. For simplification, the user could be provided with a drag and drop feature where the questions could be dragged and dropped in the desired areas. During processing, the system will recall the predetermined optimized search query associated with the question and process it for its assigned area or set of pixels of the display page layout.

A user's live book can be saved so that it can be retrieved again at a later time. For these subsequent retrievals, the live book can be set to self-update itself before being presented to the user so that it has the most current information.

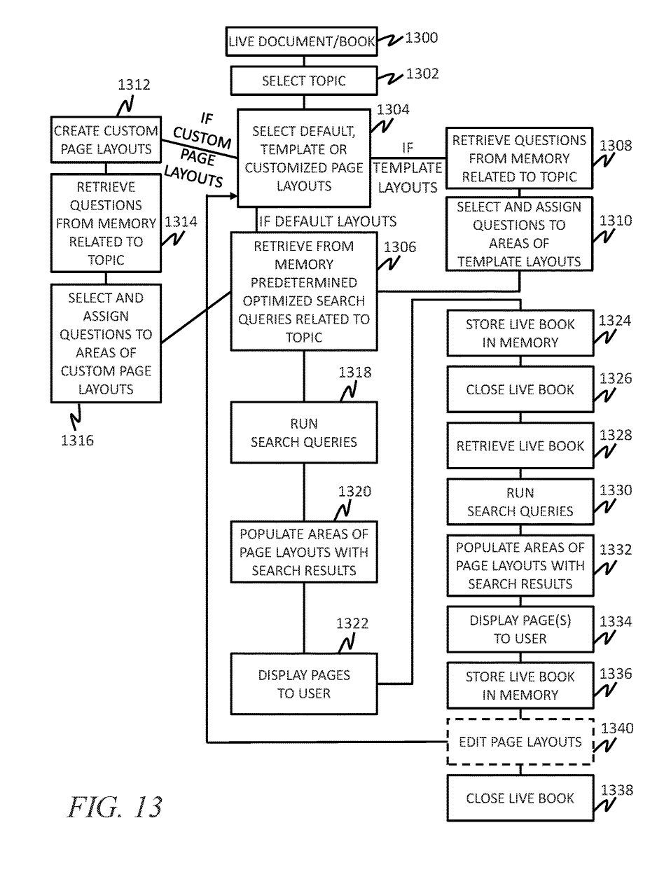

FIG. 13 illustrates an exemplary flow diagram for generating a live book 1300. The first step is to select a topic for the book 1302. The user also will be provided with an opportunity to select the type of display page layout for the pages of the book 1304. The user could be given three options: (1) a default layout created by the developer; (2) a palette of templates created by the developer from which to select; or (3) a customization feature for the user to develop custom display page layouts. If the default layout is selected, the process retrieves from memory the predetermined optimized search queries associated with the topic 1306.

If the template layout feature is selected, the system retrieves from memory a number of templates from which the user can select. The user can select the same template for all of the display pages of the book or can select different templates for different display pages of the book. The system may present to the user a list of question associated with the topic 1308 stored memory. Next, the user can select and assign questions from the list to specific areas on the templates 1310. After assigning the questions to areas on the templates, the system retrieves from memory the predetermined optimized search queries associated with the questions 1306.

If the customize layout feature is selected, the system enables the user to configure the display pages into areas to form custom layouts. The areas can be of any shape, including rectangular, triangular, circular or oval. After the customized layouts are complete, the system may retrieve from memory a list of questions associated with the topic 1314. Next, the user can select and assign questions from the list to specific areas on the custom layouts 1316. After the assigning the questions to areas on the custom layouts, the system retrieves from memory the predetermined optimized search queries associated with the questions 1306.

After retrieving the predetermined optimized search queries, the system executes the searches 1318 in a searchable environment. The searchable environment can include the World Wide Web or one or more searchable collections of information. The collections of information could be databases created for a specific collection of information for a live document or could have been created for other tasks but can support the creation of a desired live document presentation. The databases could be accessible via an intranet or the internet. The searches are preferably done in pre-selected sources or databases. If done on the World Wide Web, the searches are preferably done in preselected sources or websites available on the World Wide Web. As mentioned above, the searches can be run one at a time or in parallel to increase the generation speed of the live book. As the results from the searches are received, the system will populate the associated or assigned areas on the display page layouts with the appropriate results 1320. Once the areas are populated, the system will display the pages of the live book to the user 1322. The live book also may be stored in memory 1324 so that it can be easily retrieved again later. Once finished with the live book, it can be closed 1326.

Later, the live book can be retrieved from memory 1328. The system can automatically retrieve and run the predetermined optimized search queries again 1330 so that the most up to date information is captured and displayed on the pages of the live book. The frequency of refreshing and updating of the information could be changed. For example, the frequency can be based on a time period, when new information is available corresponding to a search query, manually, when the live document is opened, or a combination of one or more of these trigger events. The update feature also can be turned on or off. As the results from the searches are received, the system will populate the assigned or associated areas of the display page layouts with the appropriate results 1332. Once the areas are populated, the system will display the pages of the live book to the user 1334. The live book also may be stored in memory again 1336 so that in can be easily retrieved again later. Once finished with the live book, it can be closed 1338. There also may be provided the ability to revisit the page layout feature in order to edit the page layouts 1340. The edit feature could take the user back to the layout selection feature 1304.

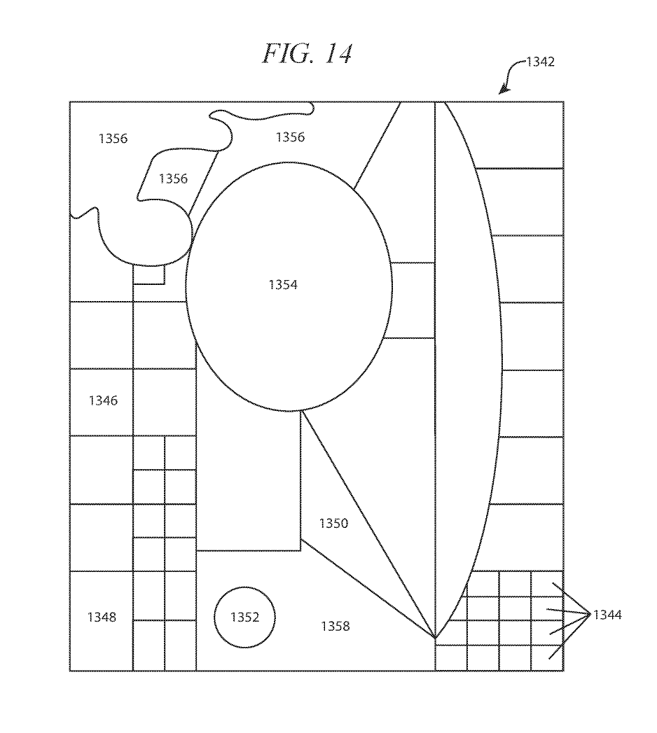

FIG. 14 illustrates an example of a live document display page 1342 having areas of a variety of shapes and sizes, each area could be associated with a predetermined optimized search. For example, the areas 1344 could be an individual pixel, where each pixel could be associated with a predetermined optimized search. The areas also could be a set of pixels defining common shapes, such as a square 1346, rectangle 1348, triangle 1350, circle 1352 or oval 1354, where at least one pixel of each shape could be associated with a predetermined optimized search. Further, the areas could be a combination of various shapes or a set of pixels that defines a free form area 1356. Each one of these shaped areas could have at least one pixel associated with at least one predetermined optimized search. An area also could wrap around another area. For example, a polygonal area 1358 wraps around a circular area 1352. Overall, there is no limitation on the size, shape or layout of the areas or the number of areas on a single or multi-display page of a live document.

As mentioned, the present approaches provide multiple advantages. In one advantage, and with respect to medical information, rapid, efficient, relevant medical search results are achieved. The present approaches also provide universal search capabilities (e.g., for text, images, video, sound, color, odor, etc.), as well as mobile device access for these searches. The present approaches provide the ability to email or print results, and improve dissemination of medical information thus improving medical care. Furthermore, the present approaches provide cost reduction in medical care due to time saved.

As mentioned above, these approaches can be used in other fields of interest beyond the medical fields. For example, other fields could include accounting, legal, equipment repair, software, engineering, research, manufacturing and sports just to name a few.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A non-transitory computer readable medium device storing instructions that when executed by a processing device for a computing device causes the computing device to perform operations for retrieving and presenting information to a user comprising:
presenting one or more initial predetermined topics stored in memory to a user, the one or more initial predetermined topics being determined by one or more providers of the instructions prior to performing operations for retrieving and presenting information to a user;
obtaining a topic selection from the user from the one or more initial predetermined topics;
based upon the topic selection, automatically retrieving from memory one or more questions, the one or more questions being determined by one or more providers of the instructions prior to performing operations for retrieving and presenting information to the user, each of the questions being linked to at least one of a plurality predetermined optimized search queries stored in memory, each of the plurality of predetermined optimized search queries being complete and generated and tested by one or more providers of the instructions prior to performing operations for retrieving and presenting information to the user;
receiving a question selection from the user from the one or more predetermined questions associated with the topic selection;
retrieving automatically from memory the linked at least one of the plurality of predetermined optimized search queries based upon the question selection of the user; and
receiving automatically search results accomplished by executing the linked at least one of the plurality of predetermined optimized search queries and presenting automatically the search results to the user.

2. The device of claim 1 further comprising instructions for accepting user input indicating a new question.

3. The device of claim 1 further comprising instructions ordering the one or more questions based upon a predetermined criteria, such predetermined criteria being statistical based so that questions of the one or more questions being used more are ranked higher in ordering the questions of the one or more questions over time.

4. The device of claim 1 wherein the search results comprise images and/or videos.

5. The device of claim 1 wherein the predetermined optimized search queries are optimized according to expert knowledge and search techniques including best Boolean search approaches.

6. The device of claim 1 further comprising instructions for storing the search results and retrieving the stored search results.

7. The device of claim 1 wherein the topic selection and question selection are saved on a favorites list as a short cut to perform the exact search again to obtain updated results.

8. A non-transitory computer readable medium device storing instructions that when executed by a processing device for a computing device causes the computing device to perform operations for retrieving and presenting information to a user comprising:
providing an application at the computing device, in memory of the computing device being stored one or more initial predetermined topics and a plurality of embedded predetermined questions, one or more of the plurality of predetermined questions being associated with each topic of the one or more initial predetermined topics, the one or more initial predetermined topics and the plurality of predetermined questions being determined by one or more providers of the instructions and the plurality of predetermined questions prior to use by the user, a plurality of predetermined optimized search queries selectively linked to the embedded plurality of predetermined questions, and identification of a plurality of pre-selected websites used by the predetermined optimized search queries for searching, the identification of the plurality of pre-selected websites being done by one or more providers of the instructions prior to use by the user, the predetermined optimized search queries being complete and created and tested by one or more providers of the instructions prior to use by the user without user input;
retrieving the one or more initial predetermined topics stored in the memory;
obtaining a topic selection from a user from the one or more initial predetermined topics, the topic selection obtained via user action at a user interface of the computing device;
based upon the topic selection, retrieving automatically one or more of the plurality of embedded questions;
receiving a question from the user selected from the retrieved one or more of the embedded plurality of questions;
retrieving automatically from the memory a predetermined optimized search query from the predetermined optimized search queries based upon the question selected by the user;
receiving automatically search results accomplished by execution of the retrieved predetermined optimized search query through only the internet in the plurality of pre-selected websites; and
presenting automatically the search results to the user.

9. The device of claim 8 further comprising instructions for ordering the plurality of predetermined questions based upon a predetermined criteria, such predetermined criteria being statistical based so that questions of the plurality of predetermined questions being used more are ranked higher in ordering the questions of the plurality of predetermined questions over time.

10. The device of claim 8 wherein the search results comprise images and/or videos.

11. The device of claim 8 wherein the predetermined optimized search queries are optimized according to expert knowledge and search techniques including best Boolean search approaches approach.

12. The method of claim 8 further comprising instructions for storing the search results and retrieving the stored search results.

13. A non-transitory computer readable medium storing instructions that when executed by a processing device for a computing device causes the computing device to perform operations for retrieving and presenting a live digital book to a user comprising:
presenting initially at least one predetermined book identification to a user, the at least one predetermined book identification being determined by one or more providers of the instructions prior to performing operations for retrieving and presenting a digital book to a user;
obtaining a book selection from the user from the at least one predetermined book identification presented, the book selection obtained via user action at a user interface of a computing device;
automatically retrieving from the memory at least one predetermined optimized search query associated with the book selection made by the user, the association between the at least one predetermined optimized search query and the book selection being made by one or more developers of the instructions prior to performing operations for retrieving and presenting a digital book to the user, the at least one predetermined optimized search query being complete and created and tested by one or more providers of the instructions prior to performing operations for retrieving and presenting a digital book to the user;
executing automatically the at least one predetermined optimized search query via only the internet;
receiving automatically search results accomplished by execution of the at least one predetermined optimized search query;
automatically formatting the search results into a digital book format; and
presenting automatically the digital book formatted search results to the user.

14. The device of claim 13 wherein the digital book includes at least two chapters and the book selection comprises a selection of a book or selection of one or more portions of a book.

15. The device of claim 13 wherein the book selection is selected a second time and the digital book formatted search results being updated and presented to the user.

16. The device of claim 13 wherein the digital book formatted search results includes citations to supporting materials, the citations being provided with hyperlinks.

17. The device of claim 13 further comprising the book selection being selected a second time and the digital book formatted search results being updated and presented to the user.

18. The device of claim 13 wherein the digital book formatted search results further comprising images and/or video.

19. The device of claim 13 further comprising instructions for automatically formatting the search results into a predefined display format, wherein the predefined display format is predefined before execution of the predetermined optimized search by associating at least one of the at least one predetermined optimized search query with a predesignated area on one or more display pages so that results from the predetermined optimized search area populate the predesignated area and displaying the one or more pages to the user on a display of a computing device.

20. The method of claim 19 wherein the predesignated area is at least one pixel.
